(19) United States
(12) Patent Application Publication
(10) Pub. No.: US 2025/0310874 A1
(43) Pub. Date: Oct. 2, 2025

(54) TERMINAL APPARATUS, BASE STATION APPARATUS, CONTROL METHOD, AND COMPUTER-READABLE STORAGE MEDIUM THAT REALIZE POWER SAVING IN COMMUNICATION SYSTEM

(71) Applicant: KDDI CORPORATION, Tokyo (JP)

(72) Inventors: Yanwei LI, Tokyo (JP); Hiroki TAKEDA, Tokyo (JP); Yasuki SUZUKI, Tokyo (JP); Masahito UMEHARA, Tokyo (JP)

(73) Assignee: KDDI CORPORATION, Tokyo (JP)

(21) Appl. No.: 19/234,711

(22) Filed: Jun. 11, 2025

Related U.S. Application Data
(63) Continuation of application No. PCT/JP2023/042477, filed on Nov. 28, 2023.

(30) Foreign Application Priority Data
Dec. 19, 2022 (JP) 2022-202317

(51) Int. Cl. H04W 52/02; H04B 17/318; H04W 8/08

(52) U.S. Cl. CPC H04W 52/0206; H04B 17/328; H04W 8/08

(57) ABSTRACT

A terminal apparatus in a wireless communication network that provides a communication service to the terminal apparatus with use of at least one of a plurality of cells obtains, with respect to each of neighbor cells that neighbor a camp-on cell on which the terminal apparatus is camping, information indicating whether a power saving function for stopping transmission of system information has been enabled, and transmits, in a case where a radio quality of a signal transmitted on a power saving cell on which the power saving function has been enabled satisfies a camp-on cell movement condition, a request message for requesting stoppage of the power saving function to a base station apparatus that provides the power saving cell.

### CROSS-REFERENCE TO RELATED APPLICATION(S)

This application is a continuation of International Patent Application No. PCT/JP2023/042477 filed on Nov. 28, 2023, which claims priority to and the benefit of Japanese Patent Application No. 2022-202317 filed on Dec. 19, 2022, the entire disclosures of which are incorporated herein by reference.

### BACKGROUND OF THE INVENTION

### Field of the Invention

The present invention relates to a control technique for realizing wireless communication with low power consumption.

### Description of the Related Art

In the 3rd Generation Partnership Project (3GPP®), suppression of power consumption in a network has been discussed as an important issue. 3GPP Written Contributions, R1-2203173 proposes to save power by stopping transmission of at least a part of Synchronization Signal/Physical Broadcast Channel block (SSB) and System Information Block Type1 (SIB1), which are conventionally supposed to be constantly transmitted on each component carrier (CC), on a part of CCs. 3GPP Written Contributions, R1-2203173 proposes that information for connection to the CC on which transmission of at least a part of SSB and SIB1 is stopped is transmitted on another CC. Note that throughout the present embodiment, “CC” may be replaced with “cell”.

A method of managing the foregoing power saving function is unclear at the present moment, and there has been a demand for a technique to efficiently manage such a method.

### SUMMARY OF THE INVENTION

The present invention provides a technique to efficiently manage a power saving function that is achieved by stopping transmission of SSB and SIB1 on a part of cells.

According to one aspect of the present invention, there is provided a terminal apparatus in a wireless communication network that provides a communication service to the terminal apparatus with use of at least one of a plurality of cells, the terminal apparatus comprising: an obtainment unit configured to, with respect to each of neighbor cells that neighbor a camp-on cell on which the terminal apparatus is camping, obtain information indicating whether a power saving function for stopping transmission of system information has been enabled; and a transmission unit configured to, in a case where a radio quality of a signal transmitted on a power saving cell on which the power saving function has been enabled satisfies a camp-on cell movement condition, transmit a request message for requesting stoppage of the power saving function to a base station apparatus that provides the power saving cell.

According to one aspect of the present invention, there is provided a base station in a wireless communication network that provides a communication service to a terminal apparatus with use of at least one of a plurality of cells, the base station comprising: an obtainment unit configured to obtain, from each of one or more neighbor base stations that respectively provide one or more neighbor cells that neighbor a cell provided by the base station, information indicating whether a power saving function for stopping transmission of system information has been enabled on the neighbor base station; and a notification unit configured to notify a terminal apparatus camping on the cell provided by the base station of the information which has been obtained by the obtainment unit and which indicates whether the power saving function has been enabled on the neighbor base stations.

Further features of the present invention will become apparent from the following description of exemplary embodiments with reference to the attached drawings.

### BRIEF DESCRIPTION OF THE DRAWINGS

FIG. 1 is a diagram showing an exemplary configuration of a wireless communication network;

FIG. 2 is a diagram showing examples of information of which a terminal apparatus is notified;

FIG. 3 is a diagram showing an exemplary hardware configuration of an apparatus;

FIG. 4 is a diagram showing an exemplary functional configuration of a base station apparatus;

FIG. 5 is a diagram showing an exemplary functional configuration of the terminal apparatus;

FIG. 6 is a diagram showing an example of a flow of processing executed in the wireless communication network; and

FIG. 7 is a diagram showing an example of a flow of processing executed in the wireless communication network.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### (Network Configuration)

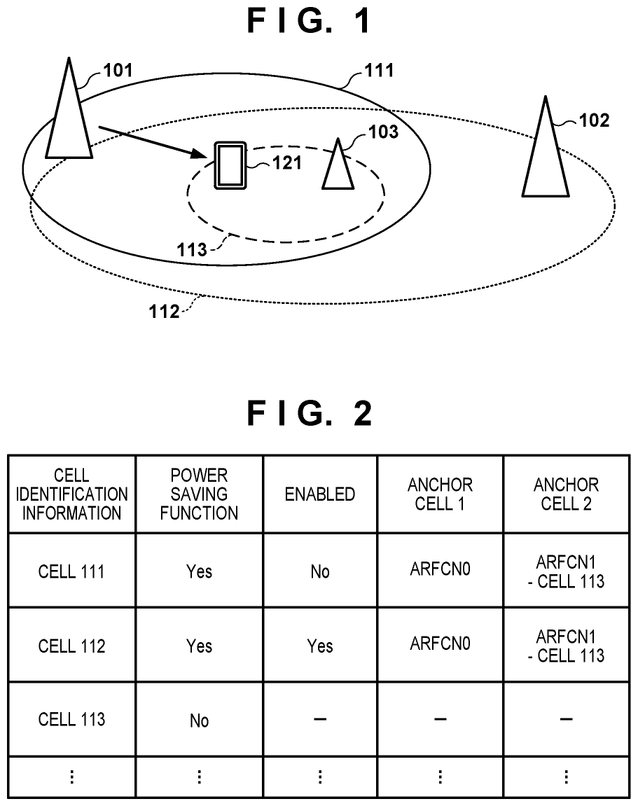

FIG. 1 shows an exemplary configuration of a wireless communication network according to the present embodiment. This wireless communication network is a cellular communication system conforming with, for example, the cellular communication standards of the 3rd Generation Partnership Project (3GPP®). The wireless communication network is configured to include, for example, a base station apparatus 101 to a base station apparatus 103 and a terminal apparatus 121, and provides a wireless communication service as a result of one of the plurality of base station apparatuses establishing connection with the terminal apparatus 121. For example, it is assumed here that the base station apparatus 101 provides a first cell 111, the base station apparatus 102 provides a second cell 112, and the base station apparatus 103 provides a third cell 113. Note that the “cell” mentioned here may be replaced with a component carrier (CC). Here, the first cell 111 to the third cell 113 may be provided using different frequencies (CC), or may be provided using the same CC. Note that although FIG. 1 shows only three base station apparatuses and one terminal apparatus to simplify the explanation, a large number of base station apparatuses and terminal apparatuses can naturally exist. Also, one base station apparatus can provide a plurality of cells (a plurality of CCs). Furthermore, one base station apparatus may provide a plurality of cells (CCs) with use of wireless transmission/reception devices that are arranged at different positions. Note that the plurality of base station apparatuses may be configured to perform communication for exchanging control information with one another via, for example, an Xn interface, an S1 interface, and the like.

Conventionally, the base station apparatus 101 to the base station apparatus 103 are configured to transmit Synchronization Signal/Physical Broadcast Channel block (SSB) and System Information Block Type1 (SIB1) on each of a plurality of cells (CCs). That is to say, on each cell, SSB and SIB1 are always transmitted periodically. For this reason, the base station apparatus 101 to the base station apparatus 103 consume power for transmission of these SSB and SIB1.

In contrast, as described in 3GPP Written Contributions, R1-2203173, power consumption in a second cell (CC) can be reduced by transmitting connection information (e.g., Master Information Block (MIB) and SIB1) for the second cell on a first cell different from the second cell, without transmitting SSB and SIB1 on the second cell. On the other hand, in this case, when the terminal apparatus 121 searches for a connection destination on the second cell, because MIB, SIB1, and the like are not transmitted on the second cell, the terminal apparatus 121 cannot be on standby or establish connection on the second cell when it has observed only radio signals of this second cell. That is to say, unless the terminal apparatus 121 executes observation processing on the first cell on which MIB and SIB1 of the second cell are transmitted, the terminal apparatus 121 cannot obtain information of the second cell, and cannot be on standby or establish connection on the second cell.

Here, for example, assume that the base station apparatus 102 has stopped transmission of system information, such as MIB and SIB1, on the second cell 112. In this case, in order to specify another cell on which MIB and SIB1 for the second cell 112 are transmitted, the terminal apparatus 121 can end up in observing radio signals transmitted on a large number of cells. Therefore, in a case where a large number of cells are provided around the terminal apparatus 121, the terminal apparatus 121 could possibly require a long period of time to obtain information of the second cell 112. For example, in a case where the terminal apparatus 121 does not know which one of the first cell 111 and the third cell 113 is transmitting the system information that has been stopped from being transmitted on the second cell 112 in FIG. 1, it is necessary to observe radio signals transmitted from the base station apparatus on each cell.

According to the present embodiment, in view of the foregoing issue, a cell on which the terminal apparatus 121 is camping (a camp-on cell) is notified of information related to a cell that transmits the system information that has been stopped from being transmitted on the second cell 112. For example, assume that the terminal apparatus 121 is camping on the first cell 111, and the system information (MIB and SIB1) for the second cell 112 is transmitted on the third cell 113. At this time, information for allowing the terminal apparatus 121 to specify that the system information for the second cell is transmitted on the third cell 113 is provided on the first cell 111. This information can include, for example, information indicating a cell that has a power saving function of stopping transmission of the system information. This information can be provided as, for example, information in which information for identifying a cell, such as a Physical Cell identity and a Cell identity, is associated with information indicating the presence or absence of the power saving function. In the example of FIG. 1, an identifier of the second cell 112 and information indicating the presence of the power saving function are associated with each other, and the terminal apparatus 121 is notified of them on the first cell 111. Also, this information may include, for example, information indicating whether this power saving function has been enabled in the cell that has this power saving function. For example, in one example, the first cell 111 could possibly have the power saving function but have not enabled this power saving function. In this case, the first cell 111 can notify the terminal apparatus 121 of information in which identification information of the first cell 111, the presence of the power saving function, and a disabled state of the power saving function are associated with one another.

Furthermore, this information can include information indicating a cell that provides the system information in a case where transmission has been stopped by the power saving function. This information may be, for example, information of a frequency. In one example, system information of a cell on which the power saving function has been enabled may be provided in all of the cells in a specific frequency; in this case, information indicating this specific frequency can be provided as information indicating the cells that provide the system information in a case where transmission has been stopped by the power saving function. In this case, identification information of specific cells may not be included. For example, a notification of information of the frequency in which the third cell 113 is provided can be provided as information indicating the third cell 113 that provides the system information that is stopped from being transmitted on the second cell 112. Note that information indicating a frequency can be the absolute radio-frequency channel number (ARFCN). Also, in addition to or in place of information of a frequency, identification information that specifies an individual cell may be provided as information indicating the cell that provides the system information that has been stopped from being transmitted. Note that there may be a plurality of cells that provide the system information that has been stopped from being transmitted; a notification of only information of frequencies may be provided in a part of these cells, and a notification of identification information of the cells may be provided in another part of these cells. Note that the third cell 113 may also provide the information that is notified by the first cell 111 as described above. That is to say, the third cell 113 also provides a notification indicating that the second cell 112 has the power saving function, this function has been enabled on the second cell 112, and the third cell 113 provides the system information that has been stopped from being transmitted on the second cell 112.

FIG. 2 shows examples of provided information. Note that hereinafter, a cell that provides the system information that has been stopped from being transmitted may be referred to as an “anchor cell”. The examples of FIG. 2 indicate that the first cell 111 has the power saving function but has not enabled this power saving function. Also, in a case where the power saving function has been enabled and transmission of system information has been stopped on the first cell 111, this system information is provided on a cell of ARFCN0. Here, the cell of ARFCN0 (not shown) provides the system information in a case where transmission has been stopped on all of the cells included in an area in which this information is provided. A notification of only information of a frequency can be provided as a first anchor cell. Therefore, information that identifies a specific cell may not be included. Furthermore, regarding this system information, a notification of identification information of, for example, the third cell 113 of ARFCN1 can be provided as a second anchor cell. In one example, it is possibly expected that the cell of ARFCN1 does not provide the system information that has been stopped from being transmitted on cells other than the third cell 113. In this case, a notification of identification information of a cell can be provided as information of the anchor cell. Note that a notification of only identification information of a cell may be provided, and a notification of information of a frequency may not be provided. Note that system information of the first cell 111 is transmitted on the first cell 111 as the power saving function is not enabled thereon, and is not normally transmitted on an anchor cell. Note that this is an example; the system information may be provided on an anchor cell even if the power saving function is not enabled. Furthermore, the examples of FIG. 2 indicate that the second cell 112 has the power saving function and has enabled this power saving function. They also indicate that the anchor cells for the second cell 112 are the same as the anchor cells for the first cell 111. As the power saving function has been enabled on the second cell 112, system information thereof is provided on the anchor cells. The examples of FIG. 2 indicate that the third cell 113 does not have the power saving function. Therefore, on the third cell 113, the power saving function is not enabled, and anchor cells are not set, either.

Note that, on the first cell 111, the terminal apparatus 121 may be notified of information excluding information related to the first cell 111, for example. Similarly, on the third cell 113, terminal apparatuses therearound may be notified of information excluding information related to the third cell 113. Naturally, a notification of information including the information related to the first cell 111 may be provided on the first cell 111, and a notification of information including the information related to the third cell 113 may be provided on the third cell 113. Note that although FIG. 2 shows only information related to three cells, no limitation is intended by this. That is to say, information of which a terminal apparatus is notified on each cell includes information of cells around that cell (and information of that cell as necessary); thus, in a case where a large number of cells exist around that cell, the terminal apparatus is notified of information related to these large number of cells. Note that the cells therearound may be neighbor cells only, or may include cells other than neighbor cells within a certain distance range.

Once a terminal apparatus has received this information, when the terminal apparatus is to obtain the system information related to the second cell 112 that has been stopped from being transmitted, the terminal apparatus obtains information on an anchor cell. In one example, in a case where a cell on which the terminal apparatus is camping is an anchor cell, the terminal apparatus receives information on that cell. On the other hand, in a case where a cell on which the terminal apparatus is not camping is an anchor cell, the terminal apparatus can move to the anchor cell and receive information on this anchor cell.

The following describes a method in which, in a case where a cell on which a terminal apparatus is camping is an anchor cell, the terminal apparatus obtains system information that has been stopped from being transmitted on another cell which has the power saving function and on which the power saving function has been enabled (hereinafter referred to as a “power saving cell”). For example, the anchor cell can transmit the system information that has been stopped from being transmitted through broadcast on a regular basis. In this case, the anchor cell can transmit a cell identifier of the power saving cell and the system information that has been stopped from being transmitted, such as MIB and SIB1 of the power saving cell, in association with each other. Note that the anchor cell may transmit a part or all of SIBx (x≥2) other than SIB1, in addition to MIB and SIB1. Also, the anchor cell may transmit scheduling information (SI-SchedulingInfo) of SIB of the power saving cell. Using schedulingInfoList included in SI-SchedulingInfo that is provided together with identification information of the power saving cell, the terminal apparatus can recognize which one of MIB, SIB1, and SIBx (x>2) of the power saving cell is transmitted through broadcast. Then, the terminal apparatus can receive MIB or SIB as necessary by receiving a transport block via which each piece of information is transmitted. Note that a base station apparatus on the anchor cell transmits MIB and SIB of a power saving cell for which “Broadcasting” has been set in schedulingInfoList through broadcast. On the other hand, the base station apparatus on the anchor cell does not transmit MIB and SIB of a power saving cell for which “notBroadcasting” has been set in schedulingInfoList through broadcast.

Note that in a case where the base station apparatus on the anchor cell has received a request signal from the terminal apparatus in relation to MIB and SIB of a power saving cell for which “notBroadcasting” has been set in schedulingInfoList, the base station apparatus can provide these pieces of information to this terminal apparatus. The request signal can be, for example, an RRCSystemInfoRequest message, which is a message in a radio resource control (RRC) layer. Using the RRCSystemInfoRequest message, the terminal apparatus can make a request for obtainment of system information for which “notBroadcasting” has been set in schedulingInfoList to the base station apparatus. Note that the base station apparatus on the anchor cell need not transmit all of MIB and SIB of a power saving cell through broadcast. In this case, upon obtaining identification information of a power saving cell and schedulingInfoList in which “notBroadcasting” has been set for all of MIB and SIB, the terminal apparatus can receive MIB and SIB by transmitting a request signal designating system information that is requested to be received.

Furthermore, upon establishing connection with the terminal apparatus, the base station apparatus on the anchor cell may provide this terminal apparatus with system information related to a power saving cell that has not been transmitted. For example, in a case where the terminal apparatus has transitioned from an RRC Idle state to an RRC_Connected state on the anchor cell, the base station apparatus on the anchor cell can provide the terminal apparatus with system information of a power saving cell that has not been transmitted by using, for example, an individual RRC message. The terminal apparatus can make a request for provision of system information that is not to be transmitted through broadcast according to SI-SchedulingInfo (for which “notBroadcasting” has been set) by transmitting a UEInformationRequest to the anchor cell. The base station apparatus on the anchor cell can provide the system information of the power saving cell that is not transmitted through broadcast by using dedicatedSIB1-Delivery and dedicatedSystemInformationDelivery included in the UEInformationResponse. Note that the anchor cell may function as an anchor cell for a plurality of power saving cells; in this case, the terminal apparatus can obtain system information that is not transmitted on the plurality of power saving cells from the base station apparatus on the anchor cell. For example, the terminal apparatus can make a request to the anchor cell by using an individual RRC message, such as a UEInformationRequest, in relation to each of the plurality of power saving cells. For example, the terminal apparatus can obtain necessary information by transmitting, to the base station apparatus on the anchor cell, a request signal in which identification information of a power saving cell and the type of requested system information are associated with each other.

As stated earlier, in a case where a cell on which the terminal apparatus is not camping is an anchor cell, the terminal apparatus can move to the anchor cell and receive information on this anchor cell. Here, for example, the terminal apparatus may move to the anchor cell and obtain information before determining that cell reselection is to be performed in favor of a power saving cell, or may move to the anchor cell and obtain information after determining that cell reselection is to be performed in favor of a power saving cell.

For example, assume that the terminal apparatus 121 has recognized that the second cell 112 has the power saving function and this function has been enabled thereon, and that an anchor cell for this second cell 112 is the third cell 113, based on a signal received on the first cell 111 on which the terminal apparatus 121 is camping. In this case, the terminal apparatus can measure the radio quality of SSB and SIB of the third cell 113 acting as the anchor cell, even if the result of measurement of radio signals of the second cell 112 acting as a power saving cell does not satisfy a predetermined condition, such as a condition where the second cell 112 is a target of cell selection and cell reselection. Then, in a case where the result of measurement of SSB and SIB of the third cell 113 satisfies the predetermined condition (e.g., in a case where the radio quality is sufficiently favorable), the terminal apparatus can obtain system information of the second cell 112 by decoding these SSB and SIB of the third cell 113. Also, in a case where a plurality of anchor cells have been designated, the terminal apparatus may specify one anchor cell that satisfies a certain condition among these anchor cells, and decode SSB and SIB transmitted on this cell. Here, the first cell 111 may notify the terminal apparatus of a reception timing of information transmitted by the third cell 113 acting as the anchor cell. This allows the terminal apparatus to receive signals transmitted on the third cell 113 while camping on the first cell 111. Note that at the reception timing of which the terminal apparatus has been notified on the first cell 111, the terminal apparatus stops reception of signals on the first cell 111, and executes reception processing for information transmitted on the third cell 113. Therefore, the first cell 111 can issue an instruction about the reception timing so that the terminal apparatus receives information from the anchor cell at a timing other than a timing at which the terminal apparatus transmits a paging signal. Furthermore, in a case where the terminal apparatus has been instructed to receive information from the anchor cell at a timing at which the terminal apparatus transmits a paging signal, it is possible to determine which one of the reception of the paging signal and the reception of information from the anchor cell is to be executed.

Note that the terminal apparatus 121 is configured to receive, from the first cell 111 on which it is currently camping, values indicating cell-selection priority degrees in a conventional manner. In a case where the radio quality of the first cell 111 on which the terminal apparatus 121 is currently camping has degraded and fallen under a predetermined reference level, the terminal apparatus 121 measures the radio quality of a neighbor cell with a priority degree lower than a priority degree of this first cell 111 on which it is currently camping. Here, for example, depending on the relationship between a priority degree of the second cell 112 in the power saving state and a priority degree of the third cell 113 acting as an anchor cell, a situation could possibly arise in which only radio signals of the second cell 112 in the power saving state are measured, and radio signals of the third cell 113 acting as the anchor cell are not measured. For example, measurement of the second cell 112 is performed but measurement of the third cell 113 is not performed in a case where the priority degree of the second cell 112 is equal to or higher than the priority degree of the first cell 111, the priority degree of the third cell 113 is lower than the priority degree of the first cell 111, and the radio quality of the first cell 111 is not equal to or lower than a predetermined value. In this case, the terminal apparatus 121 can measure a part of signals transmitted from the second cell 112, but does not measure the third cell 113; therefore, it is possibly expected that system information that has been stopped from being transmitted on the second cell 112 cannot be attained. For this reason, in the present embodiment, for example, the terminal apparatus may be configured to measure an anchor cell, too, when starting the measurement of a power saving cell, regardless of the priority degree of the anchor cell. Also, the terminal apparatus may change the priority degree of the anchor cell indicated by an instruction from a base station apparatus to the priority degree of the power saving cell. In this way, when the power saving cell is measured, the terminal apparatus can reliably obtain system information related to this power saving cell. Note that the terminal apparatus is notified of information of the priority degrees via cellReselectionPriority designated in SIB2, SIB3, SIB4, or an RRC Release message.

Note that the terminal apparatus may decode SSB and SIB of an anchor cell regardless of the radio qualities of synchronization signals and SSB of the anchor cell. In one example, the terminal apparatus can start decoding processing for SSB and SIB of the anchor cell in a case where the radio quality of a power saving cell satisfies a criterion for cell reselection. In a case where the terminal apparatus has failed in decoding of SSB and SIB as a result of an attempt to decode these pieces of information regardless of the radio quality of the anchor cell, the terminal apparatus can re-execute the obtainment and decoding of these pieces of information after a certain time period has elapsed. Also, in a case where the terminal apparatus has kept failing in and has not completed reception processing for system information of the power saving cell on the anchor cell, either a predetermined number of times in a row, or over a predetermined time period, the terminal apparatus may exclude the power saving cell associated with this anchor cell from the targets of cell selection and cell reselection. Note that the first cell 111 on which the terminal apparatus is currently camping can notify the terminal apparatus of the predetermined number of times or the predetermined time period. In a case where a plurality of anchor cells exist, the terminal apparatus may use another anchor cell different from an anchor cell on which decoding of information has failed as an anchor cell for the power saving cell.

Also, the terminal apparatus may attempt to decode SSB and SIB of the third cell 113 acting as the anchor cell in a case where the result of measurement of radio signals of the second cell 112 acting as the power saving cell satisfies the predetermined condition, such as the condition where the second cell 112 is a target of cell selection and cell reselection. That is to say, the terminal apparatus may attempt to decode SSB and SIB on the third cell 113 in a case where the second cell 112 has been decided as a move destination cell resulting from cell selection or cell reselection. Note that the terminal apparatus may attempt to decode SSB and SIB on the third cell 113 before deciding the second cell 112 as a move destination cell resulting from cell selection or cell reselection although the result of measurement of radio signals of the second cell 112 satisfies the predetermined condition. Furthermore, the terminal apparatus may decode SSB and SIB of the third cell 113 in a case where both of the result of measurement of radio signals of the second cell 112 acting as the power saving cell, and the result of measurement of radio signals of the third cell 113 acting as the anchor cell, satisfy the predetermined condition. For example, the terminal apparatus can decode SSB and SIB of the third cell 113 in a case where the second cell 112 satisfies the condition where the second cell 112 is a target of cell selection and cell reselection, and the radio quality is sufficiently favorable to the point where SSB and SIB of the third cell can be decoded.

In one example, the terminal apparatus can measure the radio quality of the second cell 112 in the power saving state, and further measure the radio quality of the third cell 113 acting as the anchor cell for the second cell 112 regardless of the radio quality of the second cell 112. Then, the terminal apparatus executes decoding of SSB and SIB of the third cell 113 in a case where the radio quality of the third cell 113 is equal to or higher than a predetermined threshold at the point when the second cell 112 has satisfied a cell movement condition. On the other hand, the terminal apparatus does not decode SSB and SIB of the third cell 113 in a case where the radio quality of radio signals of the third cell 113 is equal to or lower than the predetermined threshold. Thereafter, the terminal apparatus can execute decoding of SSB and SIB of the third cell 113 in a case where the radio quality of radio signals of the third cell 113 has become equal to or higher than the predetermined threshold while the second cell 112 remains to satisfy the cell movement condition. Note that the first cell 111 on which the terminal apparatus is camping can notify the terminal apparatus of the predetermined threshold mentioned here. This can prevent a waste of power of the terminal apparatus caused by unnecessary execution of decoding processing in a situation where the radio quality of the third cell 113 is not favorable and the probability that decoding of SSB and SIB of the third cell 113 fails is high.

Note that the terminal apparatus can refrain from decoding SSB and SIB of the third cell 113 acting as the anchor cell before the second cell 112 acting as the power saving cell satisfies a criterion for cell reselection or cell reselection. That is to say, the terminal apparatus can start receiving SSB of the third cell 113 acting as the anchor cell and decode SIB when the radio quality of the second cell 112 has satisfied the criterion for cell selection or cell reselection. The terminal apparatus attempts to decode SSB and SIB of the third cell 113 on the condition that the second cell 112 satisfies a camp-on cell movement condition. Note that the terminal apparatus can decide not to regard the second cell 112 as a move destination cell resulting from cell selection or cell reselection in a case where a predetermined time period has elapsed without succeeding in decoding of SSB and SIB of the third cell 113. Also, even before the predetermined time period elapses, the terminal apparatus can decide not to regard the second cell 112 as a move destination cell resulting from cell selection or cell reselection also upon entering a state where the second cell 112 does not satisfy the camp-on cell movement condition (e.g., a state where the radio quality does not satisfy the criterion) without succeeding in decoding of SSB and SIB of the third cell 113. In this case, the terminal apparatus stops reception processing for system information of the second cell 112 in response to a change in a state of the second cell 112 after the reception processing for the system information of the second cell 112 has started. Furthermore, the terminal apparatus may decide not to regard the second cell 112 as a move destination cell resulting from cell selection or cell reselection in a case where the number of attempts in decoding SSB and SIB of the third cell 113 has reached a predetermined number without succeeding in such decoding, or upon a change to a state where the second cell 112 does not satisfy the camp-on cell movement condition before the number of attempts in decoding reaches the predetermined number. Note, for example, the base station apparatus on the first cell 111 can notify the terminal apparatus of the predetermined time period or the predetermined number mentioned here.

Note that the condition for moving between cells to camp on through cell selection or cell reselection is that neighbor cells include a cell on which the radio quality is equal to or higher than a certain value within a certain time period, and the terminal apparatus recognizes cells that satisfy this condition as candidate cells for cell reselection. In response to measurement of neighbor cells or a serving cell, the terminal apparatus ranks the cells that satisfy the cell movement condition based on cell-selection priority degrees and the radio qualities, such as reference signal received powers (RSRP). These ranks are set to be higher for higher priority degrees, and for higher radio qualities. Then, the terminal apparatus starts cell reselection in favor of a cell with the highest rank. Note that the terminal apparatus obtains the aforementioned certain time period as Treselection, and the aforementioned certain value as Thresh, from a cell on which it is currently camping.

Note that in a case where the terminal apparatus does not hold information of the power saving cell that has been stopped from being transmitted on the power saving cell, such as a case where a cell on which the terminal apparatus is currently camping is not an anchor cell, the terminal apparatus may request the network to stop the power saving function on the power saving cell in order to obtain necessarily information directly from the power saving cell, rather than from an anchor cell. For example, in a case where the radio quality of signals transmitted on the power saving cell satisfies the camp-on cell movement condition, the terminal apparatus transmits, to the base station apparatus on the camp-on cell, a message for requesting stoppage of the power saving function on the power saving cell. Upon receiving this message, the base station apparatus on the camp-on cell transmits a message requesting stoppage of the power saving function to the base station apparatus that provides the power saving cell. Here, in general, in a case where a certain quality degradation has been confirmed on the camp-on cell, the terminal apparatus starts measuring the radio quality of a cell that has a lower cell-selection priority degree than the camp-on cell. At this time, in a case where a priority degree lower than the priority degree of the camp-on cell has been designated as a cell-selection priority degree of the power saving cell, the terminal apparatus may request stoppage of the power saving function of the power saving cell when starting the measurement of the radio quality of the power saving cell after the radio quality degradation on the camp-on cell has been confirmed. Note that in a case where the terminal apparatus holds, in advance, information for transmission of uplink signals to the power saving cell, the terminal apparatus may transmit the request message to the power saving cell, rather than to the camp-on cell. Furthermore, the terminal apparatus may request a plurality of power saving cells, at a time, to stop the power saving functions of the plurality of power saving cells by using one uplink signal (e.g., one RRC message, such as RRCSystemInfoRequest).

Upon receiving the request for stoppage of the power saving function, the base station apparatus on the power saving cell determines whether to restart the transmission of system information, such as MIB and SIB1, that has been stopped from being transmitted. Then, in a case where this base station apparatus has determined to restart the transmission of the system information, it notifies a base station apparatus on a neighbor cell of the fact that the power saving function has been stopped. Note that this neighbor cell can be a cell on which the terminal apparatus that has transmitted the request for stoppage of the power saving function is camping. Also, this neighbor cell may include, for example, an anchor cell. However, no limitation is intended by this; every base station apparatus that has notified the terminal apparatus of the enabled state of the power saving function and information indicating an anchor cell (information shown in FIG. 2) in relation to the power saving cell can be notified of the fact that the power saving function has been stopped. Upon receiving the notification of stoppage of the power saving function from the power saving cell, the base station apparatus on the camp-on cell changes information of the enabled state of the power saving function of the power saving cell in the information shown in FIG. 2, and starts transmitting the changed information. By receiving such information, the terminal apparatus can specify that the power saving cell has stopped the power saving function and started operations as a normal cell. Furthermore, a notification indicating that the power saving cell has stopped the power saving function may be transmitted separately to the terminal apparatus. The terminal apparatus can receive system information for a cell that has stopped the power saving function from that cell. On the other hand, the base station apparatus on the anchor cell can stop the distribution of the system information for the power saving cell. However, no limitation is intended by this; the base station apparatus on the anchor cell may continue the distribution of the system information for the power saving cell.

Note that in a case where the base station apparatus on the power saving cell has determined not to restart the transmission of the system information, it can transmit, for example, information that enables specification of rejection of the request, or retaining of the enabled state of the power saving function, to the base station apparatus on the camp-on cell of the terminal apparatus that has transmitted the request signal, or to the terminal apparatus. In this case, the terminal apparatus can obtain the system information of the power saving cell from the anchor cell in the above-described manner. Also, the terminal apparatus may decide not to regard the power saving cell as a target of cell selection or cell reselection. In this case, the terminal apparatus may exclude this power saving cell from targets of cell selection or cell reselection for a predetermined time period. Furthermore, in a case where the terminal apparatus has not received a notification indicating that the transmission of the system information is restarted for a predetermined time period after the transmission of the aforementioned request signal, the terminal apparatus may determine that the power saving function has been retained on the power saving cell, and obtain the system information of the power saving cell from the anchor cell. That is to say, in a case where the terminal apparatus has not received a notification indicating that the transmission of the system information is restarted for a predetermined time period after the transmission of the aforementioned request signal, the terminal apparatus may execute processing similar to processing of the case where the terminal apparatus has received the information that enables specification of rejection of the request, or retaining of the enabled state of the power saving function.

Note that the base station apparatus on the power saving cell may determine to stop the power saving function and restart the transmission of the system information in a case where it has received a request for stoppage of the power saving function a predetermined number of times or more from a plurality of terminal apparatuses within a predetermined time period. Note that this is one example, and whether to stop the power saving function may be decided based on other criteria. For example, the base station apparatus on the power saving cell may determine not to stop the power saving function in a case where the percentage of a time period for which the power saving function has been enabled within a predetermined time period is equal to or smaller than a predetermined value.

Also, in a case where the terminal apparatus has moved to a cell that has transitioned from a power saving cell to a normal-state cell (as a result of making a cell reselection in favor of that cell) and completed the reception of necessary announcement information on that cell, the terminal apparatus may request a base station apparatus on that cell to enable the power saving function. In this case, upon receiving the request to enable the power saving function, the base station apparatus on that cell determines whether to enable the power saving function. Then, in a case where the base station apparatus on that cell has determined to enable the power saving function, it enables the power saving function, and stops the transmission of at least a part of system information that has been transmitted. Furthermore, the base station apparatus on that cell notifies a base station apparatus on a neighbor cell, such as a cell on which the terminal apparatus was camping before the cell reselection, of the fact that the power saving function has been enabled. Based on the received information, the base station apparatus on the neighbor cell updates the information shown in FIG. 2, of which the terminal apparatus is to be notified, to indicate that the power saving function has been enabled on the cell that has transmitted such information, and transmits updated signals. In this way, the terminal apparatus can efficiently obtain system information of each cell while saving power throughout the system.

Note that the information shown in FIG. 2 can be transmitted using one of System Information Block Type2 (SIB2), System Information Block Type3 (SIB3), and System Information Block Type4 (SIB4) in, for example, each cell that is not currently executing the power saving function. Conventionally, a terminal apparatus obtains information of a neighbor cell by receiving SIB2 to SIB4 transmitted from a base station apparatus on a cell on which the terminal apparatus is currently camping. This information of the neighbor cell may be used also to provide a notification indicating the presence or absence of the aforementioned power saving function, an enabled state of this function, information of an anchor cell, and the like. Note that upon obtaining this information of the neighbor cell, the terminal apparatus measures the radio quality of the neighbor cell based on this information. For example, the information of the neighbor cell can include information of a cell-selection priority degree, and the terminal apparatus can execute processing for, for example, measuring the radio quality periodically with respect to a neighbor cell that has a higher cell-selection priority degree than the cell on which the terminal apparatus is currently camping, and measuring the radio quality only in a case where the radio quality of the cell on which the terminal apparatus is currently camping has degraded to a threshold or below with respect to a neighbor cell that has a lower cell-selection priority degree than the cell on which the terminal apparatus is currently camping.

### (Apparatus Configuration)

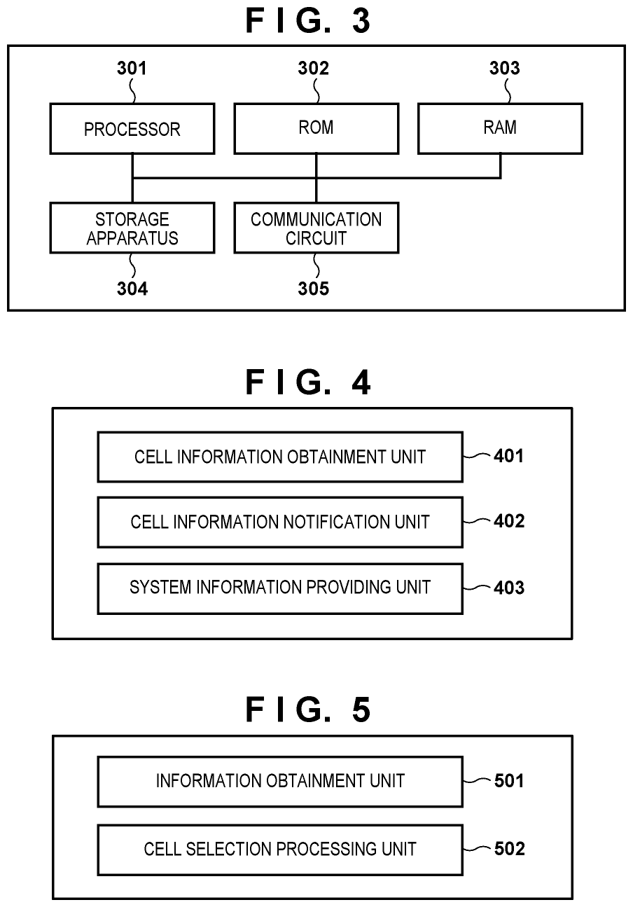

An exemplary hardware configuration of a base station apparatus and a terminal apparatus will be described using FIG. 3. In one example, the base station apparatus and the terminal apparatus are configured to include a processor 301, a ROM 302, a RAM 303, a storage apparatus 304, and a communication circuit 305. The processor 301 is a computer configured to include one or more processing circuits, such as a general-purpose central processing unit (CPU) and an application-specific integrated circuit (ASIC), and executes entire processing of the apparatus and each type of processing described above by reading out and executing a program stored in the ROM 302 or the storage apparatus 304. The ROM 302 is a read-only memory that stores a program related to processing executed by the base station apparatus and the terminal apparatus, and information of, for example, various types of parameters. The RAM 303 is a random-access memory that functions as a working space when the processor 301 executes the program, and also stores temporary information. The storage apparatus 304 is composed of, for example, an attachable and removable external storage apparatus or the like. The communication circuit 305 is composed of, for example, a circuit for wireless communication based on LTE or 5G. Note that although FIG. 3 shows one communication circuit 305, the base station apparatus and the terminal apparatus can include a plurality of communication circuits. For example, the base station apparatus and the terminal apparatus can include an antenna shared by wireless communication circuits for LTE and 5G. Note that the base station apparatus and the terminal apparatus may include an antenna for LTE and an antenna for 5G separately. Also, the base station apparatus can further include a wired communication circuit that is used when communicating with nodes of another base station apparatus and a core network. Furthermore, the terminal apparatus may include a communication circuit for another wireless communication network, such as a wireless LAN. Note that the base station apparatus and the terminal apparatus may include separate communication circuits 305 respectively for a plurality of usable frequency bands, or may include a shared communication circuit 305 for at least a part of these frequency bands.

FIG. 4 is a diagram showing an exemplary functional configuration of a base station apparatus. The base station apparatus is configured to include, for example, a cell information obtainment unit 401, a cell information notification unit 402, and a system information providing unit 403. Note that FIG. 4 shows only the functions that are particularly relevant to the present embodiment, and the illustration of various types of other functions that can be included in the base station apparatus is omitted. For example, the base station apparatus naturally includes other functions that are generally included in a base station apparatus based on LTE or 5G. Also, the functional blocks of FIG. 4 are schematically shown; the functional blocks may be realized in an integrated manner, or each functional block may be further divided. Furthermore, each function of FIG. 4 may be realized by, for example, the processor 301 executing a program stored in the ROM 302 or the storage apparatus 304, or may be realized by, for example, a processor included inside the communication circuit 305 executing predetermined software. Note that regarding the details of processing executed by each functional unit, the following does not describe the aforementioned details, and provides an overview of only general functions thereof.

The cell information obtainment unit 401 exchanges, with a neighbor cell, whether the self-apparatus supports the power saving function, whether the power saving function has been enabled in a case where this function is supported, and information of an anchor cell in a case where the power saving function has been enabled. For example, the base station apparatus on the first cell 111 obtains, from the base station apparatus on the second cell 112, information indicating that the power saving function has been supported and enabled on the second cell 112, an anchor cell is the third cell 113, and the like. Also, the base station apparatus on the first cell 111 can receive, from the base station apparatus on the third cell 113, a notification indicating that the third cell 113 does not support the power saving function. Furthermore, the base station apparatus on the first cell 111 can notify the base station apparatus on the second cell 112 and the base station apparatus on the third cell 113 of information indicating that the power saving function has been supported but has not been enabled on the first cell 111, an anchor cell is the third cell 113 in a case where the power saving function has been enabled, and the like. Note that at least a part of these pieces of information may be set in advance by, for example, a telecommunications company and accordingly obtained by each base station apparatus, rather than through information exchange between base station apparatuses. In one example, information indicating whether the power saving function has been supported and information of an anchor cell may be set in advance, and only information indicating whether the power saving function has been enabled may be exchanged between base station apparatuses. Each base station apparatus can be notified of the advance setting by the telecommunications company from, for example, a predetermined control apparatus (not shown) via the network.

The cell information notification unit 402 compiles the pieces of information obtained by the cell information obtainment unit 401, and notifies the terminal apparatus of the same. The pieces of information notified here are, for example, the information shown in FIG. 2. Also, similarly to a conventional manner, the cell information notification unit 402 can further provide a notification of information indicating a priority degree that is intended for the terminal apparatus to perform cell selection/cell reselection with respect to each neighbor cell.

The system information providing unit 403 provides information of a cell provided by the self-apparatus, such as MIB and SIB; in addition, it provides system information that has been stopped from being transmitted on a power saving cell, such as MIB and SIB, in a case where the cell provided by the self-apparatus acts as an anchor cell for another cell. Note that the system information providing unit 403 can transmit only the system information of the cell provided by the self-apparatus in a case where the cell does not function as an anchor cell for the power saving cell. Furthermore, in a case where the self-apparatus uses the power saving function, the system information providing unit 403 may stop the transmission of a part of the system information and transmit, for example, only a part of signals, such as synchronization signals.

FIG. 5 is a diagram showing an exemplary functional configuration of the terminal apparatus. The terminal apparatus is configured to include, for example, an information obtainment unit 501 and a cell selection processing unit 502. Note that FIG. 5 shows only the functions that are particularly relevant to the present embodiment, and the illustration of various types of other functions that can be included in the terminal apparatus is omitted. For example, the terminal apparatus naturally includes other functions that are generally included in a terminal apparatus based on LTE or 5G. Also, the functional blocks of FIG. 5 are schematically shown; the functional blocks may be realized in an integrated manner, or each functional block may be further divided. Furthermore, each function of FIG. 5 may be realized by, for example, the processor 301 executing a program stored in the ROM 302 or the storage apparatus 304, or may be realized by, for example, a processor included inside the communication circuit 305 executing predetermined software. Note that regarding the details of processing executed by each functional unit, the following does not describe the aforementioned details, and provides an overview of only general functions thereof.

The information obtainment unit 501 obtains various types of information, such as system information, from a base station apparatus therearound. The information obtainment unit 501 obtains, for example, system information transmitted from a base station apparatus on the camp-on cell. Furthermore, the information obtainment unit 501 also obtains system information of a cell that neighbors the camp-on cell. Here, for example, the information obtainment unit 501 obtains, from the base station apparatus on the camp-on cell, information that enables specification of whether one or more neighbor cells have the power saving function, whether the power saving function has been enabled in a case where the one or more neighbor cells have this function, and an anchor cell on which system information is transmitted in a case where the power saving function has been enabled. Then, regarding a power saving cell which has the power saving function and on which this power saving function has been enabled, when the information obtainment unit 501 is to obtain system information that has been stopped from being transmitted on this power saving cell, it obtains this system information from the anchor cell. The cell selection processing unit 502 executes cell selection or cell reselection based on the result of measurement of radio signals from base station apparatuses therearound. Note that, for example, the cell selection processing unit 502 can decide whether to regard a power saving cell as a target of cell selection/cell reselection based on whether system information that has been stopped from being transmitted was able to be obtained from the anchor cell. Also, in order to obtain system information of a power saving cell, the cell selection processing unit 502 may execute processing for regarding the anchor cell as a target of measurement regardless of a cell-selection priority degree of the anchor cell. Furthermore, in a case where a first priority degree of the anchor cell in cell selection is lower than a second priority degree of a power saving cell in cell selection, the cell selection processing unit 502 may regard the first priority degree as equal to the second priority degree and regard the anchor cell as a target of measurement. In addition, the cell selection processing unit 502 may decide whether to regard a power saving cell as a target of cell selection/cell reselection depending on whether the power saving function has been stopped on the power saving cell in response to a request for stopping this function.

### (Flow of Processing)

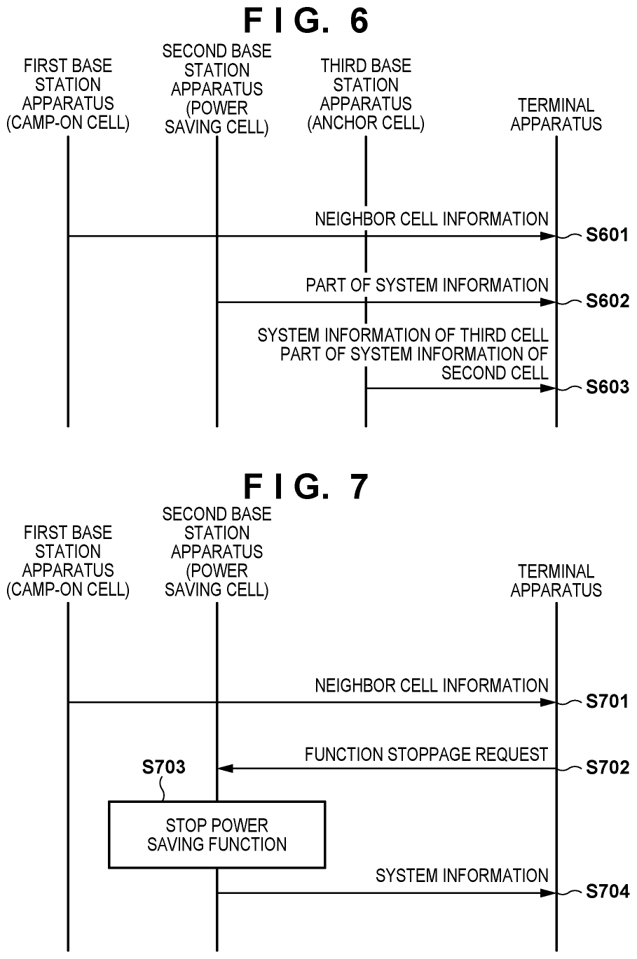

Next, an example of a flow of processing executed in a wireless communication system of the present embodiment will be described using FIG. 6. Note that the following describes an example of a case where a cell on which the terminal apparatus is camping is different from an anchor cell for a power saving cell, and the terminal apparatus receives system information that has been stopped from being transmitted on the power saving cell from the anchor cell. First, the terminal apparatus obtains information of neighbor cells from a base station apparatus on the cell on which it is currently camping (step S601). As stated earlier, with respect to each of the neighbor cells, this information includes a cell identifier, whether this cell supports the power saving function, whether the power saving function has been enabled in a case where the power saving function is supported, and information of an anchor cell that transmits the system information that has been stopped from being transmitted in a case where the power saving function has been enabled. The terminal apparatus can measure radio signals transmitted from a base station apparatus on the power saving cell, and obtain, for example, only a part of the system information that has not been stopped from being transmitted (step S602). Note that the base station apparatus on the power saving cell may not transmit the entirety of the system information, and the terminal apparatus may only measure the radio quality with respect to the power saving cell. Thereafter, based on the information obtained in step S601, the terminal apparatus obtains the system information that has been stopped from being transmitted on the power saving cell from a base station apparatus on the anchor cell (step S603).

FIG. 7 shows an example of a flow of processing for a case where the terminal apparatus transmits, to the base station apparatus on the power saving cell, a message that requests stoppage of the power saving function. Similarly to step S601, the terminal apparatus obtains information of neighbor cells from the cell on which it is currently camping (step S701). Then, in a case where the system information of the power saving cell is to be obtained, the terminal apparatus transmits a message that requests stoppage of the power saving function to the power saving cell (step S702). Note that although FIG. 7 shows exemplary processing for a case where the message is transmitted directly to the power saving cell, the message may be transmitted from the terminal apparatus to the base station apparatus on the camp-on cell, and then transferred from the base station apparatus on the camp-on cell to the base station apparatus on the power saving cell. Upon receiving this message, the base station apparatus on the power saving cell determines whether to stop the power saving function. Then, in a case where the base station apparatus on the power saving cell does not stop the power saving function, the terminal apparatus can obtain information of the power saving cell from the anchor cell through processing shown in FIG. 6. On the other hand, in a case where the base station apparatus on the power saving cell has stopped the power saving function (step S703), the terminal apparatus can obtain system information for the power saving cell from the base station apparatus on that cell (step S704).

By obtaining such system information, the terminal apparatus can execute cell reselection and camp on the power saving cell.

In the above-described manner, the terminal apparatus can camp on a part of cells and the system can be efficiently managed while saving power by stopping the transmission of system information of the part of cells. This makes it possible to contribute to Goal 9 of Sustainable Development Goals (SDGs) led by the United Nations, which is to “build resilient infrastructure, promote inclusive and sustainable industrialization, and foster innovation”.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A terminal apparatus in a wireless communication network that provides a communication service to the terminal apparatus with use of at least one of a plurality of cells, the terminal apparatus comprising:
an obtainment unit configured to, with respect to each of neighbor cells that neighbor a camp-on cell on which the terminal apparatus is camping, obtain information indicating whether a power saving function for stopping transmission of system information has been enabled; and
a transmission unit configured to, in a case where a radio quality of a signal transmitted on a power saving cell on which the power saving function has been enabled satisfies a camp-on cell movement condition, transmit a request message for requesting stoppage of the power saving function to a base station apparatus that provides the power saving cell.

2. The terminal apparatus according to claim 1, wherein
the transmission unit transmits the request message in a case where the radio quality of the signal transmitted on the power saving cell on which the power saving function has been enabled satisfies the camp-on cell movement condition, and where information for transmission of an uplink signal to the power saving cell has been held in advance.

3. The terminal apparatus according to claim 1, wherein
in a case where a notification indicating that transmission of system information is to be restarted has not been received for a predetermined time period since the transmission of the request message, the power saving cell is excluded from targets of cell selection and cell reselection.

4. The terminal apparatus according to claim 1, wherein
in a case where reception processing for system information of the power saving cell has not been completed within a predetermined time period, the power saving cell is excluded from targets of cell selection and cell reselection.

5. The terminal apparatus according to claim 4, wherein
the predetermined time period is obtained from a base station apparatus that provides the camp-on cell.

6. The terminal apparatus according to claim 1, wherein
information related to scheduling of system information that has been stopped from being transmitted on the power saving cell is obtained from a base station apparatus that provides the camp-on cell.

7. A base station in a wireless communication network that provides a communication service to a terminal apparatus with use of at least one of a plurality of cells, the base station comprising:
an obtainment unit configured to obtain, from each of one or more neighbor base stations that respectively provide one or more neighbor cells that neighbor a cell provided by the base station, information indicating whether a power saving function for stopping transmission of system information has been enabled on the neighbor base station; and
a notification unit configured to notify a terminal apparatus camping on the cell provided by the base station of the information which has been obtained by the obtainment unit and which indicates whether the power saving function has been enabled on the neighbor base stations.

8. The base station according to claim 7, wherein
the notification unit notifies the terminal apparatus of information related to scheduling of system information that has been stopped by a neighbor base station that has enabled the power saving function.

9. The base station according to claim 7, further comprising:
a reception unit configured to, in a case where the power saving function has been enabled by the base station, receive a request message for requesting stoppage of the power saving function from the terminal apparatus; and
a control unit configured to restart the transmission of the system information in response to the request message.

10. The base station according to claim 7, wherein
the neighbor base stations are notified of information indicating whether the power saving function has been enabled by the base station.

11. A control method executed by a terminal apparatus in a wireless communication network that provides a communication service to the terminal apparatus with use of at least one of a plurality of cells, the control method comprising:
obtaining, with respect to each of neighbor cells that neighbor a camp-on cell on which the terminal apparatus is camping, information indicating whether a power saving function for stopping transmission of system information has been enabled; and
transmitting, in a case where a radio quality of a signal transmitted on a power saving cell on which the power saving function has been enabled satisfies a camp-on cell movement condition, a request message for requesting stoppage of the power saving function to a base station apparatus that provides the power saving cell.

12. A control method executed by a base station in a wireless communication network that provides a communication service to a terminal apparatus with use of at least one of a plurality of cells, the control method comprising:
obtaining, from each of one or more neighbor base stations that respectively provide one or more neighbor cells that neighbor a cell provided by the base station, information indicating whether a power saving function for stopping transmission of system information has been enabled on the neighbor base station; and
notifying a terminal apparatus camping on the cell provided by the base station of the information which has been obtained and which indicates whether the power saving function has been enabled on the neighbor base stations.

13. A non-transitory computer-readable storage medium that stores a program for causing a computer included in a terminal apparatus in a wireless communication network that provides a communication service to the terminal apparatus with use of at least one of a plurality of cells to:
obtain, with respect to each of neighbor cells that neighbor a camp-on cell on which the terminal apparatus is camping, information indicating whether a power saving function for stopping transmission of system information has been enabled; and
transmit, in a case where a radio quality of a signal transmitted on a power saving cell on which the power saving function has been enabled satisfies a camp-on cell movement condition, a request message for requesting stoppage of the power saving function to a base station apparatus that provides the power saving cell.

14. A non-transitory computer-readable storage medium that stores a program for causing a computer included in a base station in a wireless communication network that provides a communication service to a terminal apparatus with use of at least one of a plurality of cells to:
obtain, from each of one or more neighbor base stations that respectively provide one or more neighbor cells that neighbor a cell provided by the base station, information indicating whether a power saving function for stopping transmission of system information has been enabled on the neighbor base station; and
notify a terminal apparatus camping on the cell provided by the base station of the information which has been obtained and which indicates whether the power saving function has been enabled on the neighbor base stations.
